(19) United States
(12) Patent Application Publication
(10) Pub. No.: US 2024/0338898 A1
(43) Pub. Date: Oct. 10, 2024

(54) METHOD FOR ADDING TEXT ON 3-DIMENSIONAL MODEL AND 3-DIMENSIONAL MODEL PROCESSING APPARATUS

(71) Applicant: MEDIT CORP., Seoul (KR)

(72) Inventors: Hotaik LEE, Seoul (KR); Seunghee KO, Seoul (KR)

(73) Assignee: MEDIT CORP., Seoul (KR)

(21) Appl. No.: 18/576,540

(22) PCT Filed: Jul. 6, 2022
(86) PCT No.: PCT/KR2022/009753

§ 371 Date: Jan. 4, 2024

(30) Foreign Application Priority Data
Jun. 7, 2021 (KR) 10-2021-0088573
Oct. 13, 2021 (KR) 10-2021-0135928

(51) Int. Cl. G06T 19/00; G06T 17/20

(52) U.S. Cl. CPC G06T 19/00; G06T 17/20; G06T 2200/24; G06T 2210/21; G06T 2210/41

(57) ABSTRACT

A method of adding text on a three-dimensional model representing an object includes obtaining three-dimensional text data corresponding to at least one character, displaying the three-dimensional text data and the three-dimensional model on a screen, determining whether the three-dimensional text data and the three-dimensional model are combinable with each other based on whether the three-dimensional text data with a certain offset applied thereto and the three-dimensional model intersect each other, and displaying a result of the determining on the screen.

### TECHNICAL FIELD

The present disclosure relates to a method of adding text on a three-dimensional model and a three-dimensional model processing apparatus.

### BACKGROUND ART

Dental computer-aided design/computer-aided manufacturing (CAD/CAM) technology is widely used in dental treatments, particularly prosthetic treatments or the like. The most important thing in dental treatments using CAD/CAM is to obtain precise three-dimensional data about the shape of an object such as a patient's tooth, gum, or jawbone. When three-dimensional data obtained from an object is used to perform a dental treatment, accurate calculation may be performed by a computer.

For example, methods such as computed tomography (CT), magnetic resonance imaging (MRI), and optical scanning may be used to obtain three-dimensional data of an object in a dental CAD/CAM treatment process.

Three-dimensional scanning apparatuses are widely used in the field of dental CAD/CAM. A three-dimensional scanning apparatus may obtain three-dimensional surface shape information by using light reflected from an object and may obtain, for example, an impression of a tooth, a plaster model obtained with respect to the impression, or a three-dimensional model of the surface of the tooth. Surface data thereof may be recorded in the form of a polygon mesh and may include position information about the vertexes of the surface of the object and connection relationship information about each of the vertexes. Alternatively, the surface data may be recorded in the form of a point cloud and may include position information about the vertexes of the surface of the object.

Recently, a technology for generating a three-dimensional object from a digital three-dimensional model through three-dimensional printing has been widely used. In order to massively manage three-dimensional objects generated through three-dimensional printing, text representing information about each of the three-dimensional objects should be added on the three-dimensional object.

### DISCLOSURE

### Technical Problem

When the surface of a three-dimensional model is not flat and is severely curved, three-dimensional text added on the three-dimensional model may be separated from the three-dimensional model in a three-dimensional printing process.

### Technical Solution

According to an aspect of the present disclosure, a method of adding text on a three-dimensional model representing an object includes obtaining three-dimensional text data corresponding to at least one character, displaying the three-dimensional text data and the three-dimensional model on a screen, determining whether the three-dimensional text data and the three-dimensional model are combinable with each other, based on whether the three-dimensional text data with a certain offset applied thereto and the three-dimensional model intersect each other, and displaying a result of the determining on the screen.

Also, in an embodiment of the present disclosure, the obtaining of the three-dimensional text data may include receiving a user input about the at least one character, obtaining contour data corresponding to the at least one character, obtaining two-dimensional mesh data by connecting a plurality of first vertexes included in the contour data, and obtaining, as the three-dimensional text data, three-dimensional mesh data including a first surface including the two-dimensional mesh data, and a second surface spaced apart from the first surface by a certain depth.

Also, in an embodiment of the present disclosure, the method may further include determining a position of the three-dimensional text data based on a user input.

Also, in an embodiment of the present disclosure, the method may further include receiving a user input for dragging the three-dimensional text data displayed on the screen to a certain position, determining a reference point based on the certain position on the screen, and determining a position of the three-dimensional text data based on a distance from the reference point to a surface of the three-dimensional model.

Also, in an embodiment of the present disclosure, the determining of the position of the three-dimensional text data may include determining the position of the three-dimensional text data at which a first surface and a second surface of the three-dimensional text data are located outside the three-dimensional model and the distance from the reference point to the surface of the three-dimensional model is minimum.

Also, in an embodiment of the present disclosure, the determining of the position of the three-dimensional text data may include determining the position of the three-dimensional text data at which a first surface and a second surface of the three-dimensional text data are located inside the three-dimensional model and the distance from the reference point to the surface of the three-dimensional model is minimum.

Also, in an embodiment of the present disclosure, the determining of whether the three-dimensional text data and the three-dimensional model are combinable with each other may include moving a second vertex included in a second surface of the three-dimensional text data by the certain offset, determining a line connecting a first vertex of a first surface of the three-dimensional text data with the moved second vertex, and determining whether the line and a surface of the three-dimensional model intersect each other.

Also, in an embodiment of the present disclosure, the determining of whether the three-dimensional text data and the three-dimensional model are combinable with each other may further include determining that the three-dimensional text data and the three-dimensional model are combinable with each other, when a number of lines intersecting the surface of the three-dimensional model among lines connecting first vertexes of the first surface of the three-dimensional text data with second vertexes moved by the certain offset is greater than or equal to a reference number.

Also, in an embodiment of the present disclosure, the displaying of the result of the determining on the screen may include determining at least one of a color, a shape, or brightness of the three-dimensional text data displayed on the screen, based on whether the three-dimensional text data and the three-dimensional model are combinable with each other.

Also, in an embodiment of the present disclosure, the method may further include obtaining a three-dimensional model with text added thereon by combining the three-dimensional text data with the certain offset applied thereto on the three-dimensional model or by deleting data corresponding to the three-dimensional text data with the certain offset applied thereto from the three-dimensional model.

According to another aspect of the present disclosure, a three-dimensional model processing apparatus for processing a three-dimensional model representing an object includes at least one processor configured to obtain three-dimensional text data corresponding to at least one character, and a display displaying the three-dimensional text data and the three-dimensional model, wherein the at least one processor is further configured to determine whether the three-dimensional text data and the three-dimensional model are combinable with each other, based on whether the three-dimensional text data with a certain offset applied thereto and the three-dimensional model intersect each other, and control the display to display a result of the determining on a screen.

Also, in an embodiment of the present disclosure, the at least one processor may be further configured to receive a user input about the at least one character, obtain contour data corresponding to the at least one character, obtain two-dimensional mesh data by connecting a plurality of first vertexes included in the contour data, and obtain, as the three-dimensional text data, three-dimensional mesh data including a first surface including the two-dimensional mesh data, and a second surface spaced apart from the first surface by a certain depth.

Also, in an embodiment of the present disclosure, the at least one processor may be further configured to determine a position of the three-dimensional text data based on a user input.

Also, in an embodiment of the present disclosure, the at least one processor may be further configured to receive a user input for dragging the three-dimensional text data displayed on the screen to a certain position, determine a reference point based on the certain position on the screen, and determine a position of the three-dimensional text data based on a distance from the reference point to a surface of the three-dimensional model.

Also, in an embodiment of the present disclosure, the at least one processor may be further configured to determine the position of the three-dimensional text data at which a first surface and a second surface of the three-dimensional text data are located outside the three-dimensional model and the distance from the reference point to the surface of the three-dimensional model is minimum.

Also, in an embodiment of the present disclosure, the at least one processor may be further configured to determine the position of the three-dimensional text data at which a first surface and a second surface of the three-dimensional text data are located inside the three-dimensional model and the distance from the reference point to the surface of the three-dimensional model is minimum.

Also, in an embodiment of the present disclosure, the at least one processor may be further configured to move a second vertex included in a second surface of the three-dimensional text data by the certain offset, determine a line connecting a first vertex of a first surface of the three-dimensional text data with the moved second vertex, and determine whether the line and a surface of the three-dimensional model intersect each other.

Also, in an embodiment of the present disclosure, the at least one processor may be further configured to determine that the three-dimensional text data and the three-dimensional model are combinable with each other, when a number of lines intersecting the surface of the three-dimensional model among lines connecting first vertexes of the first surface of the three-dimensional text data with second vertexes moved by the certain offset is greater than or equal to a reference number.

Also, in an embodiment of the present disclosure, the at least one processor may be further configured to determine at least one of a color, a shape, or brightness of the three-dimensional text data displayed on the screen, based on whether the three-dimensional text data and the three-dimensional model are combinable with each other.

Also, in an embodiment of the present disclosure, the at least one processor may be further configured to obtain a three-dimensional model with text added thereon by combining the three-dimensional text data with the certain offset applied thereto on the three-dimensional model or by deleting data corresponding to the three-dimensional text data with the certain offset applied thereto from the three-dimensional model.

### Advantageous Effects

According to the described embodiments, the risk of text being separated from a three-dimensional model in a three-dimensional printing process may be reduced.

Also, according to the described embodiments, the user may clearly recognize, on a character-by-character basis, whether a plurality of characters included in text to be input are well combined with a three-dimensional model.

### DESCRIPTION OF DRAWINGS

The present disclosure may be easily understood through the following detailed description and the accompanying drawings, in which reference numerals may refer to structural elements.

FIG. 1 is a diagram for describing a three-dimensional model processing system according to an embodiment.

FIG. 2 illustrates a block diagram of a three-dimensional model processing system according to an embodiment.

FIG. 3A describes a method of adding text on a three-dimensional model by a general three-dimensional model processing apparatus.

FIG. 3B describes a method of adding text on a three-dimensional model by a general three-dimensional model processing apparatus.

FIG. 4 illustrates a flowchart of a method of adding text on a three-dimensional model by a three-dimensional model processing apparatus, according to an embodiment.

FIG. 5A illustrates an example of a process of obtaining three-dimensional text data by a three-dimensional model processing apparatus, according to an embodiment.

FIG. 5B illustrates an example of a process of obtaining three-dimensional text data by a three-dimensional model processing apparatus, according to an embodiment.

FIG. 5C illustrates an example of a process of obtaining three-dimensional text data by a three-dimensional model processing apparatus, according to an embodiment.

FIG. 6A describes a method of determining, by a three-dimensional model processing apparatus, whether three-dimensional text data with an offset applied thereto and a three-dimensional model intersect each other, according to an embodiment.

FIG. 6B describes a method of determining, by a three-dimensional model processing apparatus, whether three-dimensional text data with an offset applied thereto and a three-dimensional model intersect each other, according to an embodiment.

FIG. 7A illustrates an example of adding text in an embossed manner on a three-dimensional model by a three-dimensional model processing apparatus, according to an embodiment.

FIG. 7B illustrates an example of adding text in an intaglio manner into a three-dimensional model a three-dimensional model processing apparatus, according to an embodiment.

FIG. 8A illustrates an example of a screen displayed by a three-dimensional model processing apparatus, according to an embodiment.

FIG. 8B illustrates an example of a screen displayed by a three-dimensional model processing apparatus, according to an embodiment.

FIG. 9 illustrates an example of result data output by a three-dimensional model processing apparatus, according to an embodiment.

FIG. 10 illustrates a block diagram of a three-dimensional model processing apparatus according to an embodiment.

### MODE FOR INVENTION

The specification clarifies the scope of the present disclosure and describes the principle of the present disclosure and embodiments so that those of ordinary skill in the art may implement the present disclosure. The described embodiments may be implemented in various forms.

Throughout the specification, like reference numerals will denote like elements. The specification may not describe all elements of the embodiments, and general descriptions in the art to which the present disclosure belongs or redundant descriptions between the embodiments will be omitted for conciseness. The term ‘unit’ (or part or portion) used herein may be implemented as software or hardware, and depending on the embodiments, a plurality of ‘units’ may be implemented as one element (or unit) or one ‘unit’ may include a plurality of elements. Hereinafter, the operation principle and embodiments of the present disclosure will be described with reference to the accompanying drawings.

Herein, an ‘object’ may be a target for photography and may include a human, an animal, or a portion thereof. For example, the object may include a portion of a body (an organ or the like), an artificial structure attachable onto or insertable into the object, or a phantom. For example, the object may include a tooth, a gum, at least some area of an oral cavity (mouth), an artificial structure insertable into an oral cavity (e.g., an orthodontic device including brackets and wires, an implant, an artificial tooth, a dental restoration including inlays, onlays, and the like, or an orthodontic assistance tool inserted into an oral cavity), and/or a tooth or gum with an artificial structure attached thereto.

Herein, an ‘image’ may be a two-dimensional image of an object or a three-dimensional model or a three-dimensional image stereoscopically representing an object. Herein, the image may include both a two-dimensional frame and a three-dimensional frame. For example, the image may include a two-dimensional frame including two-dimensional images obtained from different viewpoints with respect to an object or a three-dimensional frame represented in the form of a point cloud or in the form of a polygon mesh.

Also, herein, ‘data’ may refer to information required to two-dimensionally or three-dimensionally represent an object, for example, raw data obtained from at least one image sensor. Particularly, the raw data may be two-dimensional images obtained to generate a three-dimensional model of an object. The raw data may be two-dimensional images of different viewpoints obtained by a plurality of image sensors when an object is scanned by using a three-dimensional scanner (e.g., an intraoral scanner). Also, herein, ‘three-dimensional data’ may refer to a three-dimensional model representing the stereoscopic characteristics of an object including at least one of a tooth, a gum, and an artificial structure attached to a tooth or gum.

Hereinafter, embodiments will be described in detail with reference to the accompanying drawings.

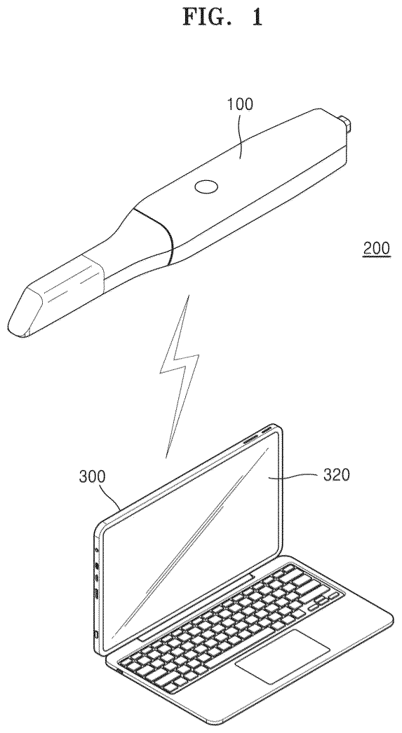

FIG. 1 is a diagram for describing a three-dimensional model processing system according to an embodiment.

As illustrated in FIG. 1, a three-dimensional model processing system 200 according to an embodiment of the present disclosure may include a three-dimensional scanning apparatus 100 and a three-dimensional model processing apparatus 300.

The three-dimensional model processing system 200 according to an embodiment may use the three-dimensional scanning apparatus 100 to project pattern light on an object and scan the object with the pattern light projected thereon, thereby obtaining a three-dimensional model representing a shape of the object by using the principle of triangulation by modification of a pattern. However, a method of obtaining the three-dimensional model by the three-dimensional scanning apparatus 100 is not limited thereto, and the three-dimensional model may be obtained in various ways depending on implementation methods.

The three-dimensional scanning apparatus 100 according to an embodiment may transmit raw data obtained from the object to the three-dimensional model processing apparatus 300. The three-dimensional model processing apparatus 300 may generate a three-dimensional model three-dimensionally representing the shape of a surface of the object based on the received raw data. The three-dimensional model may be point cloud data or polygon mesh data. The three-dimensional scanning apparatus 100 according to another embodiment may generate a three-dimensional frame by reconstructing raw data obtained from an object and transmit the generated three-dimensional frame to the three-dimensional model processing apparatus 300.

The three-dimensional scanning apparatus 100 according to an embodiment may include a medical device for obtaining a three-dimensional model of an oral cavity. Particularly, the three-dimensional scanning apparatus 100 may be an apparatus for generating a three-dimensional model of the oral cavity including at least one tooth by being inserted into the oral cavity and scanning teeth in a non-contact manner. Also, the three-dimensional scanning apparatus 100 may have a form capable of being inserted into and withdrawn from the oral cavity and may scan the inside of the patient's oral cavity by using at least one image sensor (e.g., an optical camera). Also, the three-dimensional scanning apparatus 100 may be a table scanner.

In order to image the surface of at least one of a tooth and a gum inside the oral cavity and an artificial structure insertable into the oral cavity (e.g., an orthodontic device including brackets and wires, an implant, an artificial tooth, or an orthodontic assistance tool inserted into the oral cavity) which is an object, the three-dimensional scanning apparatus 100 may obtain surface information about the object as raw data. The three-dimensional model processing apparatus 300 may obtain a three-dimensional model by performing three-dimensional operations such as merge based on the raw data and display a rendered image of the three-dimensional model on a screen.

The three-dimensional model processing apparatus 300 according to an embodiment may be connected to the three-dimensional scanning apparatus 100 through a wired or wireless communication network and may receive, from the three-dimensional scanning apparatus 100, raw data or a three-dimensional frame obtained by scanning the object by the three-dimensional scanning apparatus 100.

The three-dimensional model processing apparatus 300 may be any electronic apparatus capable of generating, processing, displaying, and/or transmitting a three-dimensional model or image of the object based on the received raw data or three-dimensional frame. For example, the three-dimensional model processing apparatus 300 may be, but is not limited to, a computing apparatus such as a smart phone, a laptop computer, a desktop computer, a PDA, or a tablet PC.

The three-dimensional model processing apparatus 300 may generate at least one of an object image and information necessary for diagnosis of the object based on the data received from the three-dimensional scanning apparatus 100 and display the generated information and/or image through a display 320.

The three-dimensional model processing apparatus 300 according to an embodiment may analyze a three-dimensional model or image of the object and process, display, and/or transmit the analysis results.

Also, the three-dimensional model processing apparatus 300 according to an embodiment may store and execute dedicated software linked to the three-dimensional scanning apparatus 100. The dedicated software may be referred to as a dedicated program or a dedicated application. When the three-dimensional model processing apparatus 300 interoperates with the three-dimensional scanning apparatus 100, the dedicated software stored in the three-dimensional model processing apparatus 300 may be connected to the three-dimensional scanning apparatus 100 to receive in real time the data obtained by scanning the object. For example, there is dedicated software for processing data obtained through intraoral scanning by the i500 product as an intraoral scanner. The three-dimensional model processing apparatus 300 may store and execute dedicated software corresponding to the i500 product. The dedicated software may perform one or more operations for obtaining, processing, storing, and/or transmitting the three-dimensional model.

The dedicated software may be stored in a processor or memory of the three-dimensional model processing apparatus 300. Also, the dedicated software may provide a user interface for using the data obtained by the three-dimensional scanning apparatus 100. A user interface screen provided by the dedicated software may include a rendered image of a three-dimensional model of the object generated according to the described embodiments. For example, in the described embodiments, the user interface screen provided by the dedicated software may be any one of the user interface screens illustrated in the following drawings.

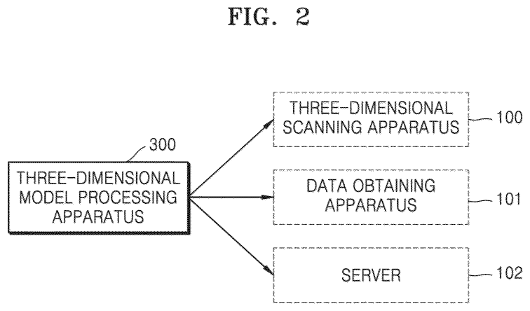

FIG. 2 illustrates a block diagram of a three-dimensional model processing system according to an embodiment.

As illustrated in FIG. 2, a three-dimensional model processing apparatus 300 according to an embodiment may be connected to an external device or an external server through a wired or wireless communication network. The three-dimensional model processing apparatus 300 according to an embodiment may obtain and process data about an object from at least one of a three-dimensional scanning apparatus 100, a data obtaining apparatus 101 (e.g., a medical diagnosis apparatus such as a computed tomography (CT) apparatus or a magnetic resonance imaging (MRI) apparatus), or a server 102. Alternatively, the three-dimensional model processing apparatus 300 according to an embodiment may obtain and process data prestored in an internal memory.

A three-dimensional model processed by the three-dimensional model processing apparatus 300 according to an embodiment may be used to generate a three-dimensional object through three-dimensional printing. In order to easily identify the three-dimensional object generated through three-dimensional printing, text representing identification information of the three-dimensional object may be added on the three-dimensional object.

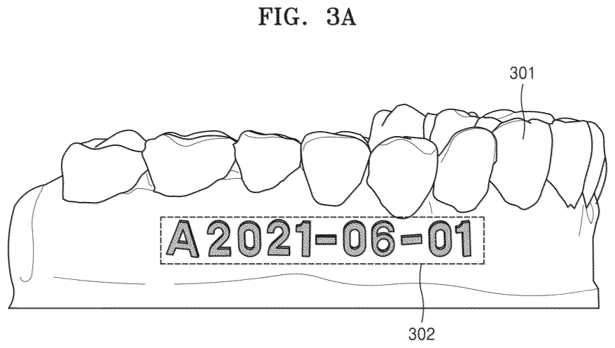

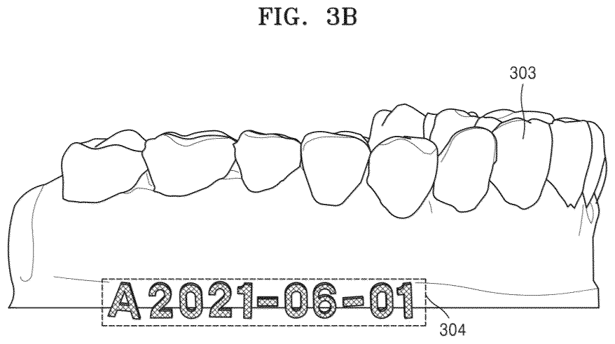

FIGS. 3A and 3B describe a method of adding text on a three-dimensional model by a general three-dimensional model processing apparatus.

As illustrated in FIG. 3A, a general three-dimensional model processing apparatus may add three-dimensional text data 302 representing a character string on a three-dimensional model 301 representing an object. When the three-dimensional text data 302 is added to an area where the surface of the three-dimensional model 301 is flat, a three-dimensional object in which a portion corresponding to the three-dimensional model 301 and a portion corresponding to the three-dimensional text data 302 are well combined with each other may be generated through three-dimensional printing.

On the other hand, as illustrated in FIG. 3B, when three-dimensional text data 304 is added to a severely-curved area on a three-dimensional model 303 or an area other than the area of the three-dimensional model 303, at least a portion of a portion corresponding to the three-dimensional text data 304 may be separated from a portion corresponding to the three-dimensional model 303 in a printing operation.

Thus, in order to ensure that the entire text including a plurality of characters may be well combined on a three-dimensional object in a three-dimensional printing process, it may be required to allow the user to easily identify an area suitable for adding the text on the three-dimensional object.

According to various embodiments of the present disclosure, in adding text on a three-dimensional model, the three-dimensional model processing apparatus 300 may determine whether three-dimensional text data may be suitably combined with the three-dimensional model and display the determination results on the screen.

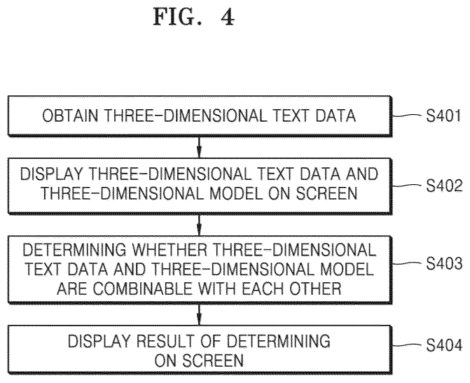

A particular method of adding text on a three-dimensional model by the three-dimensional model processing apparatus 300 according to various embodiments will be described in more detail below with reference to FIGS. 4 to 10.

FIG. 4 illustrates a flowchart of a method of adding text on a three-dimensional model by a three-dimensional model processing apparatus, according to an embodiment.

In operation S401, the three-dimensional model processing apparatus 300 according to an embodiment may obtain three-dimensional text data corresponding to at least one character.

The three-dimensional model processing apparatus 300 according to an embodiment may obtain three-dimensional text data corresponding to at least one character from an internal memory or an external device. The three-dimensional model processing apparatus 300 may receive a user input for inputting at least one character and obtain three-dimensional text data representing the at least one character based on the user input.

The three-dimensional model processing apparatus 300 according to an embodiment may receive a user input corresponding to at least one character and obtain contour data corresponding to the at least one character. The three-dimensional model processing apparatus 300 may obtain two-dimensional mesh data by connecting a plurality of first vertexes included in the contour data. The three-dimensional model processing apparatus 300 may obtain, as three-dimensional text data, three-dimensional mesh data including a first surface including two-dimensional mesh data and including a second surface spaced apart from the first surface by a certain depth.

The three-dimensional model processing apparatus 300 according to an embodiment may receive a user input corresponding to a first character string including a plurality of characters from the user. The three-dimensional model processing apparatus 300 may obtain contour data corresponding to each character included in the first character string. The three-dimensional model processing apparatus 300 may obtain two-dimensional mesh data by connecting a plurality of first vertexes included in contour data corresponding to each character. The three-dimensional model processing apparatus 300 may obtain a three-dimensional text data set including three-dimensional text data corresponding to each character included in the first character string.

In operation S402, the three-dimensional model processing apparatus 300 according to an embodiment may display the three-dimensional text data and the three-dimensional model on the screen.

The three-dimensional model processing apparatus 300 according to an embodiment may render and display the three-dimensional model on the screen. The three-dimensional model processing apparatus 300 may additionally display three-dimensional text data corresponding to at least one character input by the user on the screen with the three-dimensional model displayed thereon.

The three-dimensional model processing apparatus 300 according to an embodiment may determine a position at which the three-dimensional text data will be arranged in a three-dimensional space, based on at least one of a distance from a reference point or a reference surface to the surface of the three-dimensional model or a user input. The three-dimensional model processing apparatus 300 according to an embodiment may determine the X-axis coordinate value and Y-axis coordinate value of the three-dimensional text data. The three-dimensional model processing apparatus 300 according to an embodiment may determine, based on the determined X-axis coordinate value and Y-axis coordinate value, the Z-axis coordinate value of the three-dimensional text data to be located close to the three-dimensional model.

As an example, the three-dimensional model processing apparatus 300 may receive a user input for selecting a certain position on the screen and determine a reference point based on the certain position on the screen. The three-dimensional model processing apparatus 300 may determine the position of the three-dimensional text data based on the distance from the reference point to the surface of the three-dimensional model. The three-dimensional model processing apparatus 300 may determine the X-axis coordinate value and Y-axis coordinate value of the three-dimensional text data based on a certain position on the screen and determine the Z-axis coordinate value of the three-dimensional text data by considering the three-dimensional model.

For example, the X-axis coordinate value of the three-dimensional text data may be a value representing the position of the three-dimensional text data determined along the horizontal axis of the screen in the three-dimensional space displayed on the screen. The Y-axis coordinate value of the three-dimensional text data may be a value representing the position of the three-dimensional text data determined along the vertical axis of the screen in the three-dimensional space displayed on the screen. The Z-axis coordinate value of the three-dimensional text data may be a value representing the depth of the three-dimensional text data based on the screen in the three-dimensional space displayed on the screen.

The three-dimensional model processing apparatus 300 according to an embodiment may identify a point closest to the reference point on the surface of the three-dimensional model by projecting a virtual line from the reference point to the three-dimensional model. The three-dimensional model processing apparatus 300 may determine the Z-axis coordinate value of the three-dimensional text data such that the three-dimensional text data is attached to the identified point on the three-dimensional model.

As another example, the three-dimensional model processing apparatus 300 may arrange the three-dimensional text data at a position corresponding to a first position on the screen and may receive a user input for dragging the three-dimensional text data displayed at the first position on the screen to a second position. The three-dimensional model processing apparatus 300 may determine the X-axis coordinate value and Y-axis coordinate value of the three-dimensional text data based on a user input and determine the Z-axis coordinate value of the three-dimensional text data by considering the three-dimensional model. The three-dimensional model processing apparatus 300 may determine a reference point based on the second position on the screen and determine the Z-axis coordinate value of the three-dimensional text data based on the distance from the reference point to the surface of the three-dimensional model.

As another example, the three-dimensional model processing apparatus 300 may project a plurality of virtual lines to the three-dimensional model in the three-dimensional space displayed on the screen. The three-dimensional model processing apparatus 300 may identify the closest point on the surface of the three-dimensional model (i.e., the most protruding point on the surface of the three-dimensional model) by projecting a plurality of virtual lines to the three-dimensional model. The three-dimensional model processing apparatus 300 may position-align the three-dimensional text data set such that the point of the three-dimensional text data corresponding to a reference character is attached to the identified point on the three-dimensional model.

The three-dimensional model processing apparatus 300 may search for the most protruding area on the surface of the three-dimensional model displayed on the screen and determine the X-axis coordinate value and Y-axis coordinate value corresponding to the found area.

The three-dimensional model processing apparatus 300 may determine the Z-axis coordinate value of the three-dimensional text data based on the vertical distances from the vertexes included in the second surface of the three-dimensional text data to the found area of the three-dimensional model.

The three-dimensional model processing apparatus 300 according to an embodiment may determine the Z-axis coordinate value of the three-dimensional text data based on whether the text is input as an embossment or as an intaglio on the three-dimensional model.

As an example, when the text is input as an embossment on the three-dimensional model, the three-dimensional model processing apparatus 300 may determine the position of the three-dimensional text data such that the first surface and second surface of the three-dimensional text data are located outside the three-dimensional model. The three-dimensional model processing apparatus 300 may determine the position of the three-dimensional text data at which the sum of the vertical distances from the vertexes included in the second surface of the three-dimensional text data to the surface of the three-dimensional model is minimum.

As another example, when the text is input as an intaglio into the three-dimensional model, the three-dimensional model processing apparatus 300 may determine the position of the three-dimensional text data such that the first surface and second surface of the three-dimensional text data are located inside the three-dimensional model. The three-dimensional model processing apparatus 300 may determine the position of the three-dimensional text data at which the sum of the vertical distances from the vertexes included in the second surface of the three-dimensional text data to the surface of the three-dimensional model is minimum.

Also, the three-dimensional model processing apparatus 300 may determine an angle of the three-dimensional text data based on a normal vector of the three-dimensional text data and a normal vector of the three-dimensional model.

In operation S403, the three-dimensional model processing apparatus 300 according to an embodiment may determine whether the three-dimensional text data and the three-dimensional model are combinable with each other.

The three-dimensional model processing apparatus 300 according to an embodiment may determine whether the three-dimensional text data and the three-dimensional model are combinable with each other, based on whether three-dimensional text data with a certain offset applied thereto and the three-dimensional model intersect each other. Three-dimensional text data with an offset applied thereto may include three-dimensional text data with a depth added thereto by the offset.

The three-dimensional model processing apparatus 300 according to an embodiment may move a second vertex included in the second surface of the three-dimensional text data by a certain offset in order to obtain three-dimensional text data with an offset applied thereto. The three-dimensional model processing apparatus 300 may determine a line connecting a first vertex of the first surface of the three-dimensional text data with the moved second vertex. The three-dimensional model processing apparatus 300 may determine whether the line and the surface of the three-dimensional model intersect each other. The three-dimensional model processing apparatus 300 may determine the number of lines intersecting the surface of the three-dimensional model among the lines connecting first vertexes of the first surface of the three-dimensional text data with second vertexes moved by a certain offset is greater than or equal to a reference value and determine, based on the determination results, whether the three-dimensional text data and the three-dimensional model are combinable with each other. For example, the three-dimensional model processing apparatus 300 may determine that the three-dimensional text data and the three-dimensional model are combinable with each other, when all of the lines connecting the first vertexes of the first surface of the three-dimensional text data with the second vertexes moved by the certain offset intersect the surface of the three-dimensional model.

In operation S404, the three-dimensional model processing apparatus 300 according to an embodiment may display the determination results on the screen.

The three-dimensional model processing apparatus 300 according to an embodiment may determine at least one of the color, shape, or brightness of the three-dimensional text data displayed on the screen, based on whether the three-dimensional text data and the three-dimensional model are combinable with each other.

The three-dimensional model processing apparatus 300 according to an embodiment may differently display the case where the three-dimensional text data is combinable with the three-dimensional model and the case where the three-dimensional text data is not combinable with the three-dimensional model. For example, the three-dimensional model processing apparatus 300 according to an embodiment may display the three-dimensional text data in a first color (e.g., blue) when the three-dimensional text data is combinable with the three-dimensional model. When the three-dimensional text data is not combinable with the three-dimensional model, the three-dimensional text data may be displayed in a second color (e.g., orange).

The three-dimensional model processing apparatus 300 according to an embodiment may change the color of the three-dimensional text data from the second color to the first color, according to a user input for dragging the three-dimensional text data displayed on the screen from a first position that is not combinable with the three-dimensional model to a second position that is combinable with the three-dimensional model.

Also, the three-dimensional model processing apparatus 300 according to an embodiment may determine that the three-dimensional text data corresponding to some characters among the three-dimensional text data set corresponding to a plurality of characters is not combinable with the three-dimensional model. The three-dimensional model processing apparatus 300 may display some three-dimensional text data determined as not being combinable with the three-dimensional model differently from other three-dimensional text data. The three-dimensional model processing apparatus 300 may display whether the three-dimensional text data corresponding to a certain character among the three-dimensional text data set corresponding to a character string that the user wants to input is not combined with the three-dimensional model. Thus, the user may intuitively identify a problematic character among the characters included in the character string and modify the character string or change the position of the three-dimensional text data.

The three-dimensional model processing apparatus 300 according to an embodiment may obtain the three-dimensional model with the text added thereon when the three-dimensional text data and the three-dimensional model are combinable with each other. The three-dimensional model processing apparatus 300 may obtain the three-dimensional model with the text added thereon by combining the three-dimensional text data with a certain offset applied thereto on the three-dimensional model or deleting data corresponding to the three-dimensional text data with a certain offset applied thereto from the three-dimensional model.

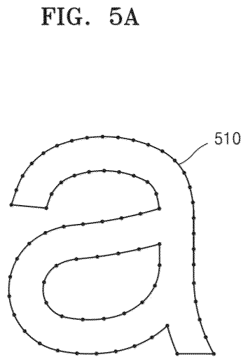

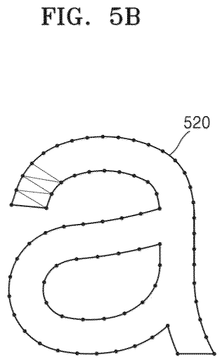

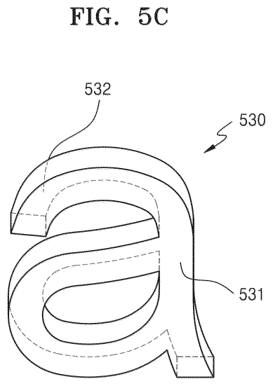

FIGS. 5A, 5B, and 5C illustrate an example of a process of obtaining three-dimensional text data by a three-dimensional model processing apparatus, according to an embodiment.

The three-dimensional model processing apparatus 300 according to an embodiment may obtain a contour data set including contour data corresponding to each of various characters. The three-dimensional model processing apparatus 300 may obtain a contour data set from an open application programming interface (API). Contour data corresponding to a certain character may include at least one closed loop and may include a plurality of points.

The three-dimensional model processing apparatus 300 according to an embodiment may obtain contour data representing at least one character corresponding to a user input from a contour data set prestored in the internal memory.

As illustrated in FIG. 5A, when receiving a user input for inputting a character ‘a’, the three-dimensional model processing apparatus 300 according to an embodiment may obtain contour data 510 representing the character ‘a’. The contour data 510 may include an outer closed loop and an inner closed loop including a plurality of first vertexes.

Next, as illustrated in FIG. 5B, the three-dimensional model processing apparatus 300 according to an embodiment may generate two-dimensional mesh data 520 by connecting the first vertexes included in the contour data.

Next, the three-dimensional model processing apparatus 300 according to an embodiment may generate three-dimensional text data based on the two-dimensional mesh data 520.

As illustrated in FIG. 5C, the three-dimensional model processing apparatus 300 according to an embodiment may generate three-dimensional text data 530 including X-axis coordinate values, Y-axis coordinate values, and Z-axis coordinate values by applying a certain depth value to two-dimensional mesh data including X-axis coordinate values and Y-axis coordinate values. The three-dimensional model processing apparatus 300 may generate, as the three-dimensional text data 530, three-dimensional mesh data including the two-dimensional mesh data obtained from the contour data as a first surface and including a second surface spaced apart from the first surface by a certain depth value.

Embodiments of the present disclosure are not limited to the example illustrated in FIG. 5B. The three-dimensional model processing apparatus 300 according to an embodiment may generate a certain vertex between the outer closed loop and inner closed loop of the contour data 510 and generate two-dimensional mesh data 520 based on the certain vertex. The three-dimensional model processing apparatus 300 may generate three-dimensional text data by applying a certain depth value to the two-dimensional mesh data 520. The three-dimensional model processing apparatus 300 may generate a line from a certain vertex in the direction of a normal vector of the two-dimensional mesh data 520 or in the opposite direction of the normal vector and determine whether the three-dimensional text data and the three-dimensional model are combinable with each other, based on whether the generated line and the three-dimensional model intersect each other.

The vertexes of a first surface 531 including the two-dimensional mesh data generated from the contour data may be referred to as first vertexes (or front vertexes), and the vertexes included in a second surface 532 with a certain depth value applied thereto from the first vertexes may be referred to as second vertexes (or back vertexes).

FIGS. 5A to 5C illustrate the case of generating the three-dimensional text data about the character ‘a’ as an example; however, the present disclosure is not limited to the illustrated example. The three-dimensional model processing apparatus 300 may obtain three-dimensional text data corresponding to various characters. Also, when a character string including a plurality of characters is input by the user, the three-dimensional model processing apparatus 300 may obtain a three-dimensional text data set corresponding to the plurality of characters.

When the three-dimensional text data is obtained, the three-dimensional model processing apparatus 300 according to an embodiment may determine a position at which the three-dimensional text data will be arranged in the three-dimensional space including the three-dimensional model. The three-dimensional model processing apparatus 300 according to an embodiment may determine the X-axis coordinate value and Y-axis coordinate value of the three-dimensional text data based on a user input or based on an area found as most protruding among some areas of the three-dimensional model. Also, the three-dimensional model processing apparatus 300 may determine the Z-axis coordinate value of the three-dimensional text data based on the position of the three-dimensional model.

Hereinafter, a particular method of determining the Z-axis coordinate value of three-dimensional text data will be described.

The three-dimensional model processing apparatus 300 according to an embodiment may position-align the three-dimensional text data on the three-dimensional model according to the following process.

The three-dimensional model processing apparatus 300 according to an embodiment may receive a user input for inputting a character string including a plurality of characters and obtain a three-dimensional text data set corresponding to the character string. The three-dimensional model processing apparatus 300 may select a reference character among the plurality of characters or a reference point determined as being located at the center of the plurality of characters.

For example, the three-dimensional model processing apparatus 300 may obtain a three-dimensional text data set corresponding to a character string “ABCDE” and select a centrally-located character “C” among the character string “ABCDE” as a reference character. For example, the three-dimensional model processing apparatus 300 may obtain a three-dimensional text data set corresponding to a character string “ABCD” and select a centrally-located character “B” or “C” among the character string “ABCD” as a reference character.

Alternatively, the three-dimensional model processing apparatus 300 may determine a three-dimensional text data set corresponding to a character string as one piece of mesh data and set a point determined as being located at the center of the determined mesh data as a reference point. For example, the three-dimensional model processing apparatus 300 may obtain a three-dimensional text data set corresponding to a character string “ABCD” and set a centrally-located point between a character “B” and a character “C” among the character string “ABCD” as a reference point.

The three-dimensional model processing apparatus 300 according to an embodiment may receive a user input for selecting a certain position on the screen (e.g., a user input for clicking a certain position on the screen) and determine the X-axis coordinate value and Y-axis coordinate value corresponding to the certain position on the screen. The three-dimensional model processing apparatus 300 may identify a point closest to the reference point on the surface of the three-dimensional model by projecting a virtual line to the three-dimensional model based on the reference point determined by the X-axis coordinate value and the Y-axis coordinate value. The three-dimensional model processing apparatus 300 may position-align the three-dimensional text data set to be adjacent to the three-dimensional model such that the point of the three-dimensional text data corresponding to the reference character is attached to the point identified on the three-dimensional model or such that the reference point of the three-dimensional text data set is attached to the point identified on the three-dimensional model.

The three-dimensional model processing apparatus 300 according to another embodiment may project a plurality of virtual lines in the Z-axis direction to the three-dimensional model in the three-dimensional space displayed on the screen. The three-dimensional model processing apparatus 300 may identify the closest point from the screen on the surface of the three-dimensional model (i.e., the most protruding point on the surface of the three-dimensional model) by projecting a plurality of virtual lines to the three-dimensional model. The three-dimensional model processing apparatus 300 may position-align the three-dimensional text data set to be adjacent to the three-dimensional model such that the point of the three-dimensional text data corresponding to the reference character is attached to the point identified on the three-dimensional model or such that the reference point of the three-dimensional text data set is attached to the point identified on the three-dimensional model.

For example, a tooth model representing the inside of the user's oral cavity may include an intraoral area representing teeth and gums and a base area supporting the intraoral area. Generally, in the case of the tooth model, because the base area protrudes compared to the intraoral area, when the user inputs text, the three-dimensional model processing apparatus 300 may search for a relatively protruding base area and position-align a three-dimensional text data set corresponding to the input text on the found base area.

Moreover, the three-dimensional model processing apparatus 300 according to an embodiment may segment the three-dimensional model. The three-dimensional model processing apparatus 300 may use a template, artificial intelligence, or the like to separate the three-dimensional model into an area corresponding to at least one tooth, an area corresponding to the gum, and/or a base area. In the three-dimensional model, an area representing the oral cavity (e.g., a tooth area and/or a gum area) may be an important area that should not be modified due to the input text. Thus, the text input by the user may be added to the base area rather than the area representing the oral cavity.

Thus, the three-dimensional model processing apparatus 300 according to an embodiment may set a locking function such that the text is not added within a certain distance with respect to each tooth identified by segmentation. When the locking function is activated, the three-dimensional model processing apparatus 300 may automatically position-align the text such that the text input by the user may be located in an area other than a set area on the three-dimensional model. For example, the three-dimensional model processing apparatus 300 may automatically position-align the text such that the text input by the user may be located in an area other than the intraoral area, that is, the base area.

Moreover, in order for the three-dimensional text data and the three-dimensional model to be well combined with each other, the vertexes of the second surface of the three-dimensional text data should contact the surface of the three-dimensional model (i.e., the mesh or vertex located on the surface of the three-dimensional model). However, when the surface of the three-dimensional model is not flat, even when some of the vertexes of the second surface of the three-dimensional text data contact the three-dimensional model, the others of the second vertexes may not contact the three-dimensional model.

Thus, the three-dimensional model processing apparatus 300 according to an embodiment may apply an offset for combination with the three-dimensional model to the three-dimensional text data. The three-dimensional model processing apparatus 300 may apply an offset to the three-dimensional text data by setting virtual vertexes that are moved by an offset from the vertexes of the second surface of the three-dimensional text data.

The three-dimensional model processing apparatus 300 according to an embodiment may set virtual third vertexes by moving the second surface vertexes in the direction of a normal vector of the second surface of the three-dimensional text data or in the opposite direction of the normal vector of the second surface. The three-dimensional model processing apparatus 300 may determine whether the three-dimensional text data and the three-dimensional model are combinable with each other, based on whether the three-dimensional text data with the offset applied thereto and the three-dimensional model intersect each other, and may display the determination results on the screen.

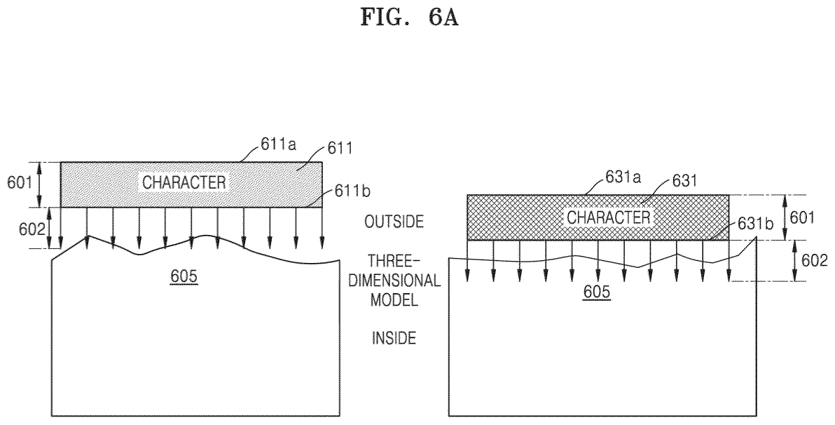

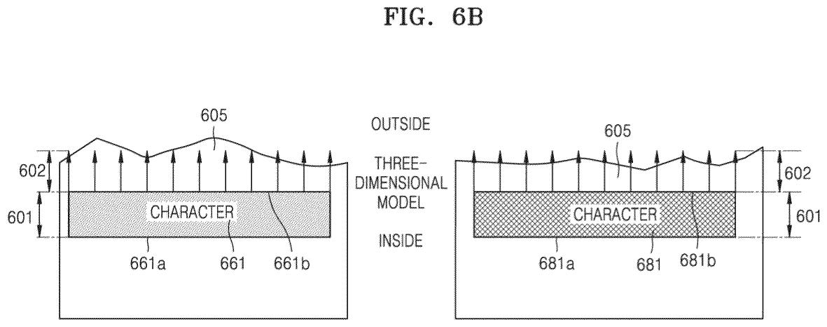

FIG. 6A describes a method of determining, by a three-dimensional model processing apparatus, whether three-dimensional text data with an offset applied thereto and a three-dimensional model intersect each other, according to an embodiment.

As illustrated in FIG. 6A, when text is input as an embossment on a three-dimensional model, the three-dimensional model processing apparatus 300 according to an embodiment may determine the position of three-dimensional text data 611 and 631 such that the three-dimensional text data 611 and 631 is located outside a three-dimensional model 605.

In FIG. 6A, the three-dimensional text data 611 may include two-dimensional mesh data generated from contour data corresponding to at least one character as a first surface 611a and may include a second surface 611b spaced apart from the first surface by a certain depth value 601.

The three-dimensional model processing apparatus 300 may move the second vertexes included in the second surface 611b of the three-dimensional text data 611 by a certain offset in order to obtain three-dimensional text data with an offset 602 applied thereto. The three-dimensional model processing apparatus 300 may determine lines connecting the first vertexes of the first surface 611a of the three-dimensional text data with the moved second vertexes. The three-dimensional model processing apparatus 300 may determine whether the lines and the surface of the three-dimensional model intersect each other. When the mesh or vertex of the surface of the three-dimensional model is located on a line having a first vertex as a start point and a second vertex moved by an offset as an end point, the three-dimensional model processing apparatus 300 may determine that the line and the surface of the three-dimensional model intersect each other.

The three-dimensional model processing apparatus 300 may determine whether the number of lines intersecting the surface of the three-dimensional model among the lines connecting the first vertexes of the first surface 611a of the three-dimensional text data with the second vertexes moved by the offset 602 is greater than or equal to a reference value. The three-dimensional model processing apparatus 300 may determine, based on the determination results, whether the three-dimensional text data 611 and the three-dimensional model 605 are combinable with each other.

Because one or more lines do not intersect the surface of the three-dimensional model 605, the three-dimensional model processing apparatus 300 according to an embodiment may determine that the three-dimensional text data 611 is not combinable with the three-dimensional model 605.

On the other hand, in FIG. 6A, the three-dimensional text data 631 may include a first surface 631a and a second surface 631b. The three-dimensional model processing apparatus 300 may determine lines connecting the first vertexes of the first surface 631a of the three-dimensional text data with the second vertexes moved by a certain offset. The three-dimensional model processing apparatus 300 may determine whether the number of lines intersecting the surface of the three-dimensional model among the lines connecting the first vertexes of the first surface 631a of the three-dimensional text data with the second vertexes moved by the offset 602 is greater than or equal to a reference value.

Because all the lines intersect the surface of the three-dimensional model 605, the three-dimensional model processing apparatus 300 according to an embodiment may determine that the three-dimensional text data 631 is combinable with the three-dimensional model 605.

FIG. 6B describes a method of determining, by a three-dimensional model processing apparatus, whether three-dimensional text data with an offset applied thereto and a three-dimensional model intersect each other, according to an embodiment.

As illustrated in FIG. 6B, when text is input as intaglio on a three-dimensional model, the three-dimensional model processing apparatus 300 according to an embodiment may determine the position of three-dimensional text data 661 and 681 such that the three-dimensional text data 661 and 681 is located inside a three-dimensional model 605.

In FIG. 6B, the three-dimensional text data 661 may include two-dimensional mesh data generated from contour data corresponding to at least one character as a first surface 661a and may include a second surface 661b spaced apart from the first surface by a certain depth value 601.

The three-dimensional model processing apparatus 300 may move the second vertexes included in the second surface 661b of the three-dimensional text data 661 by a certain offset in order to obtain three-dimensional text data with an offset 602 applied thereto. The three-dimensional model processing apparatus 300 may determine lines connecting the first vertexes of the first surface 661a of the three-dimensional text data with the moved second vertexes. The three-dimensional model processing apparatus 300 may determine whether the lines and the surface of the three-dimensional model intersect each other. When the mesh or vertex of the surface of the three-dimensional model is located on a line having a first vertex as a start point and a second vertex moved by an offset as an end point, the three-dimensional model processing apparatus 300 may determine that the line and the surface of the three-dimensional model intersect each other.

The three-dimensional model processing apparatus 300 may determine whether the number of lines intersecting the surface of the three-dimensional model among the lines connecting the first vertexes of the first surface 661a of the three-dimensional text data with the second vertexes moved by the offset 602 is greater than or equal to a reference value. The three-dimensional model processing apparatus 300 may determine, based on the determination results, whether the three-dimensional text data 661 and the three-dimensional model 605 are combinable with each other.

Because one or more lines do not intersect the surface of the three-dimensional model 605, the three-dimensional model processing apparatus 300 according to an embodiment may determine that the three-dimensional text data 661 is not combinable with the three-dimensional model 605.

On the other hand, in FIG. 6B, the three-dimensional text data 681 may include a first surface 681a and a second surface 681b. The three-dimensional model processing apparatus 300 may determine lines connecting the first vertexes of the first surface 681a of the three-dimensional text data with the second vertexes moved by a certain offset. The three-dimensional model processing apparatus 300 may determine whether the number of lines intersecting the surface of the three-dimensional model among the lines connecting the first vertexes of the first surface 681a of the three-dimensional text data with the second vertexes moved by the offset 602 is greater than or equal to a reference value.

Because all the lines intersect the surface of the three-dimensional model 605, the three-dimensional model processing apparatus 300 according to an embodiment may determine that the three-dimensional text data 681 is combinable with the three-dimensional model 605.

As illustrated in FIGS. 6A and 6B, the three-dimensional model processing apparatus 300 according to an embodiment may determine whether each three-dimensional text data corresponding to each character is combinable with the three-dimensional model. Thus, the three-dimensional model processing apparatus 300 according to an embodiment may display whether the three-dimensional text data corresponding to a certain character among the three-dimensional text data set corresponding to a character string that the user wants to input is not combined with the three-dimensional model. Thus, the user may intuitively identify a problematic character among the characters included in the character string and modify the character string. Alternatively, the user may quickly and accurately find an area suitable for input of a character string on the three-dimensional model.

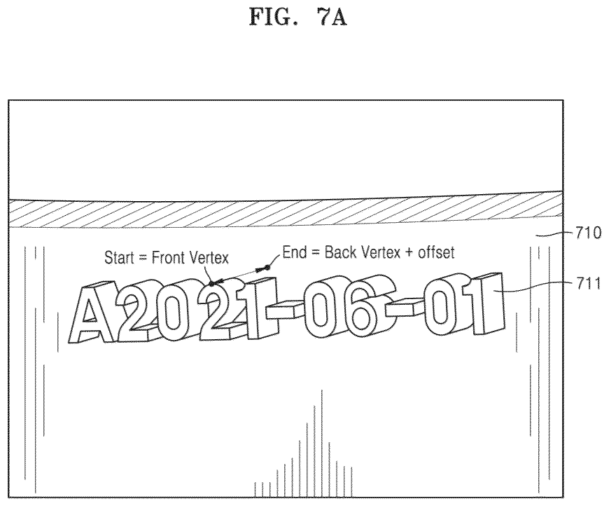

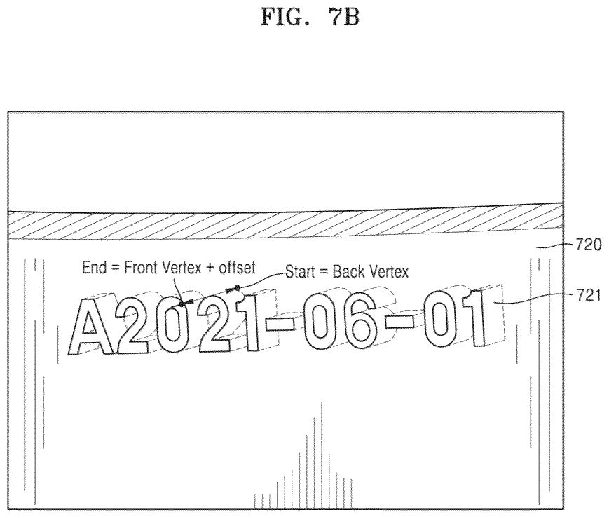

FIG. 7A illustrates an example of adding text in an embossed manner on a three-dimensional model by a three-dimensional model processing apparatus, according to an embodiment.

As illustrated in FIG. 7A, when text is input as an embossment on a three-dimensional model, the three-dimensional model processing apparatus 300 according to an embodiment may determine the position of a three-dimensional text data set 711 corresponding to a character string such that the three-dimensional text data set 711 is located outside a three-dimensional model 710.

The three-dimensional model processing apparatus 300 according to an embodiment may position-align the three-dimensional text data set 711 on the three-dimensional model 710. The three-dimensional model processing apparatus 300 may combine, on the three-dimensional model, three-dimensional mesh data including vertexes (or front vertexes) of the first surface of the three-dimensional text data corresponding to each character included in the three-dimensional text data set 711 as start points and including second vertexes (or back vertexes) moved by a certain depth value and an offset as end points.

The three-dimensional model processing apparatus 300 may determine the back vertexes of the three-dimensional text data based on the positions at which the lines connecting the first vertexes of the first surface of the three-dimensional text data with the second vertexes moved by an offset intersect the surface of the three-dimensional model 710. The three-dimensional model processing apparatus 300 may obtain three-dimensional mesh data including the vertexes of the first surface of the three-dimensional text data corresponding to each character included in the three-dimensional text data set 711 as start points and including the back vertexes newly determined based on the positions of intersection with the three-dimensional model 710 as end points.

The three-dimensional model processing apparatus 300 may add the text on the three-dimensional model by combining the obtained three-dimensional mesh data with the three-dimensional model.

FIG. 7B illustrates an example of adding text in an intaglio manner into a three-dimensional model a three-dimensional model processing apparatus, according to an embodiment.

As illustrated in FIG. 7B, when text is input as an intaglio on a three-dimensional model, the three-dimensional model processing apparatus 300 according to an embodiment may determine the position of a three-dimensional text data set 721 corresponding to a character string such that the three-dimensional text data set 721 is located inside a three-dimensional model 720.

The three-dimensional model processing apparatus 300 according to an embodiment may position-align the three-dimensional text data set 721 in the three-dimensional model 720. The three-dimensional model processing apparatus 300 may obtain three-dimensional mesh data including the vertexes of the first surface of the three-dimensional text data corresponding to each character included in the three-dimensional text data set 721 as start points and including the second vertexes moved by a certain depth value and an offset as end points.

The three-dimensional model processing apparatus 300 may determine the back vertexes of the three-dimensional text data based on the positions at which the lines connecting the first vertexes of the first surface of the three-dimensional text data with the second vertexes moved by an offset intersect the surface of the three-dimensional model 720. The three-dimensional model processing apparatus 300 may obtain three-dimensional mesh data including the vertexes of the first surface of the three-dimensional text data corresponding to each character included in the three-dimensional text data set 721 as start points and including the back vertexes newly determined based on the positions of intersection with the three-dimensional model 720 as end points.

The three-dimensional model processing apparatus 300 may add the text on the three-dimensional model by deleting the obtained three-dimensional mesh data from the three-dimensional model 720.

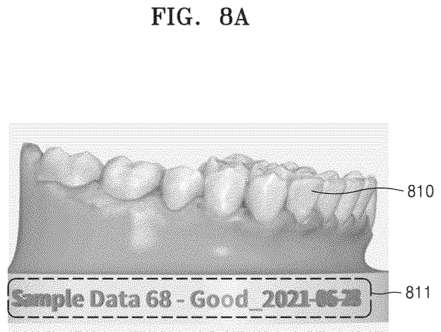

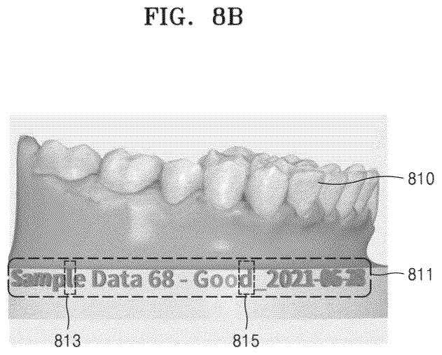

FIGS. 8A and 8B illustrate an example of a screen displayed by a three-dimensional model processing apparatus, according to an embodiment.

The three-dimensional model processing apparatus 300 according to an embodiment may position-align a three-dimensional text data set 811 on a three-dimensional model 810.

As illustrated in FIG. 8A, the three-dimensional model processing apparatus 300 according to an embodiment may determine whether the three-dimensional text data set 811 corresponding to a plurality of characters is well combined on the three-dimensional model 810. The three-dimensional model processing apparatus 300 may determine whether three-dimensional text data corresponding to each of a plurality of characters included in the three-dimensional text data set 811 is well combined on the three-dimensional model 810.

The three-dimensional model processing apparatus 300 may apply an offset to the three-dimensional text data representing each character and determine whether the three-dimensional text data is well combined on the three-dimensional model 810, based on whether the three-dimensional text data with the offset applied thereto intersects the three-dimensional model 810.

The three-dimensional model processing apparatus 300 may determine at least one of the color, shape, or brightness of the three-dimensional text data displayed on the screen, based on whether the three-dimensional text data included in the three-dimensional text data set 811 and the three-dimensional model are combinable with each other.

For example, as illustrated in FIG. 8A, the three-dimensional model processing apparatus 300 according to an embodiment may determine that all the three-dimensional text data included in the three-dimensional text data set 811 is combinable with the three-dimensional model 810 and determine the color of all the three-dimensional text data as a first color (e.g., blue).

The three-dimensional model processing apparatus 300 according to an embodiment may move the three-dimensional text data set 811 to another position based on a user input.

As illustrated in FIG. 8B, the three-dimensional model processing apparatus 300 according to an embodiment may move the three-dimensional text data set 811 in the upward direction.

As the position of the three-dimensional text data set 811 moves, the upper end portion of three-dimensional text data 813 and 815 corresponding to a character “I” and a character “d” may not contact the three-dimensional model 810.

Thus, as the position of the three-dimensional text data set 811 moves, the three-dimensional model processing apparatus 300 according to an embodiment may determine that some three-dimensional text data 813 and 815 included in the three-dimensional text data set 811 is not determinable with the three-dimensional model 810.

The three-dimensional model processing apparatus 300 may determine that the three-dimensional text data 813 and 815 corresponding to some characters among the three-dimensional text data set 811 corresponding to a plurality of characters does not intersect the three-dimensional model 810 even when even when an offset is applied thereto. The three-dimensional model processing apparatus 300 may display the colors of the three-dimensional text data 813 and 815 to be different from each other, based on the determination that the three-dimensional text data 813 and 815 is not combinable with the three-dimensional model 810.

The three-dimensional model processing apparatus 300 according to an embodiment may determine the color of some three-dimensional text data 813 and 815 as a second color (e.g., orange). For example, the three-dimensional model processing apparatus 300 may display three-dimensional text data determined as being well combined on the three-dimensional model in blue and display three-dimensional text data determined as not being well combined on the three-dimensional model in orange.

FIG. 8B illustrates an example of changing only the color of three-dimensional text data determined as not being combinable therewith; however, various embodiments of the present disclosure are not limited to the example illustrated in FIGS. 8A and 8B. Information about whether the three-dimensional text data is combinable with the three-dimensional model may be provided through various methods according to various embodiments.

For example, when it is determined that at least some of the three-dimensional text data included in the three-dimensional text data set is not combinable with the three-dimensional model, the three-dimensional model processing apparatus 300 may change the color of all the three-dimensional text data included in the three-dimensional text data set. Also, the three-dimensional model processing apparatus 300 may display some three-dimensional text data determined as not being combinable therewith differently from the other three-dimensional text data. For example, the three-dimensional model processing apparatus 300 may display at least some three-dimensional text data determined as not being combinable therewith in bold.

The three-dimensional model processing apparatus 300 according to an embodiment may obtain a three-dimensional model with text added thereon through the above process.

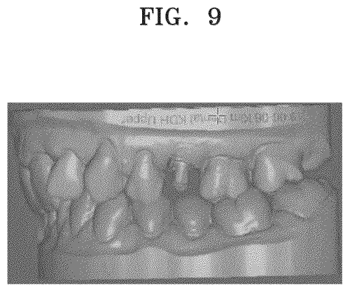

FIG. 9 illustrates an example of a three-dimensional model with text added thereon output by a three-dimensional model processing apparatus, according to an embodiment.

The three-dimensional model processing apparatus 300 according to an embodiment may obtain a three-dimensional model with text added thereon when three-dimensional text data and a three-dimensional model are combinable with each other. As illustrated in FIG. 9, the three-dimensional model processing apparatus 300 may obtain a three-dimensional model with text added thereon by combining the three-dimensional text data with a certain offset applied thereto on the three-dimensional model.

In adding the text on the three-dimensional model, the three-dimensional model processing apparatus 300 according to an embodiment may determine and display whether the three-dimensional text data corresponding to each added character is combinable with the three-dimensional model.

Furthermore, when the three-dimensional text data corresponding to a character input by the user is not combinable with the three-dimensional model, the three-dimensional model processing apparatus 300 according to an embodiment may not only display information indicating that it is not combinable therewith but also prevent the character input by the user from being added to the three-dimensional model. Thus, the user may re-input a character or change the position of the three-dimensional text data in order to add the three-dimensional text data to a position that is combinable with the three-dimensional model. By preventing the text from being added thereon when it is not combinable with the three-dimensional model, the three-dimensional model processing apparatus 300 may prevent at least a portion of a portion corresponding to the three-dimensional text data from being separated from a portion corresponding to the three-dimensional model in a three-dimensional printing operation.

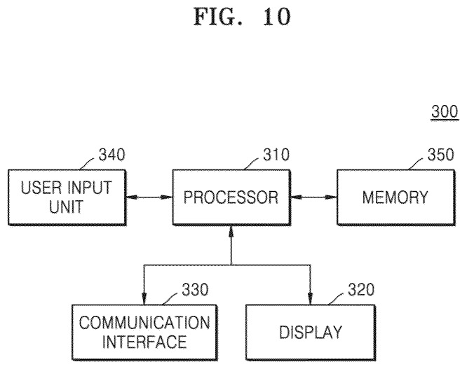

FIG. 10 illustrates a block diagram of a three-dimensional model processing apparatus according to an embodiment.

The three-dimensional model processing apparatus 300 illustrated in FIG. 10 may perform a three-dimensional model processing method according to various embodiments of the present disclosure, and the descriptions of FIGS. 1 to 9 may also be applied thereto. Thus, redundant descriptions with those described above will be omitted for conciseness.

The three-dimensional model processing apparatus 300 according to an embodiment may be connected to an external apparatus such as a three-dimensional scanning apparatus or an external server through a wired or wireless communication network and may obtain a three-dimensional model of an object.

The three-dimensional model processing apparatus 300 may be any electronic apparatus capable of generating, processing, displaying, and/or transmitting a three-dimensional image of the object based on the obtained three-dimensional model. The three-dimensional model processing apparatus 300 according to various embodiments of the present disclosure may be a fixed terminal or a mobile terminal. For example, the three-dimensional model processing apparatus 300 may be, but is not limited to, a computing apparatus such as a smart phone, a laptop computer, a desktop computer, a PDA, or a tablet PC.

Referring to FIG. 10, the three-dimensional model processing apparatus 300 may include a processor 310, a display 320, a communication interface 330, a user input unit 340, and a memory 350.

The processor 310 according to an embodiment may execute at least one instruction to control the three-dimensional model processing apparatus 300 to perform an intended operation. The at least one instruction may be stored in an internal memory (not illustrated) included in the processor 310 or in the memory 350.

The processor 310 according to an embodiment may execute at least one instruction to control at least one component included in the three-dimensional model processing apparatus 300 to perform an intended operation. Thus, although a case where the processor 310 performs a certain operation is described as an example, the processor 310 may control at least one component included in the three-dimensional model processing apparatus 300 such that the at least one component performs a certain operation.

The processor 310 according to an embodiment may include a RAM (not illustrated) that store signals or data input from outside the three-dimensional model processing apparatus 300 or is used as a storage area corresponding to various operations performed by the three-dimensional model processing apparatus 300, a ROM (not illustrated) storing a control program and/or a plurality of instructions for controlling the three-dimensional model processing apparatus 300, and at least one internal processor (not illustrated) executing at least one instruction.

Also, the processor 310 may include a graphic processor (graphic processing unit) (not illustrated) for graphic processing corresponding to video. Also, the processor 310 may be implemented as a System-on-Chip (SoC) including a combination of a core (not illustrated) and a GPU (not illustrated).

In described embodiments, the processor 310 may generate an image by rendering a three-dimensional model of an oral cavity. For example, the three-dimensional model may include surface shape information of the oral cavity including at least one of a plurality of teeth, gums, and artificial structures.

The display 320 may display a certain screen under the control by the processor 310. Particularly, the display 320 may display a user interface screen including the three-dimensional model. Alternatively, the display 320 may display a user interface screen including information related to the diagnosis and treatment of the object.

The communication interface 330 may communicate with at least one external electronic device (not illustrated) or a server (not illustrated) through a wired or wireless communication network.

The user input unit 340 may receive a user input for controlling the three-dimensional model processing apparatus 300. The user input unit 340 may include, but is not limited to, a user input device including a touch panel for sensing a user's touch, a button for receiving a user's push operation, and/or a mouse or a keyboard for designating or selecting a point on a user interface screen.

Also, the user input unit 340 may include a voice recognition device (not illustrated) for voice recognition. For example, the voice recognition device (not illustrated) may be a microphone, and the voice recognition device may receive a user's voice command or voice request. Accordingly, the processor 310 may control an operation corresponding to the voice command or voice request to be performed.

The memory 350 may store at least one instruction executed by the processor 310. Also, the memory 350 may store at least one program executed by the processor 310. The memory 350 may store data received from an external device or an external server (e.g., raw data obtained by scanning an object, two-dimensional image data, or a three-dimensional model). The memory 350 may store an object image three-dimensionally representing the object.

The processor 310 according to an embodiment of the present disclosure may control an overall operation of the three-dimensional model processing apparatus 300 by executing the program stored in the memory 350.

As to a particular method by which the processor 310 adds text on the three-dimensional model, the description of FIG. 4 may also be applied and redundant descriptions thereof will be omitted for conciseness.

The processor 310 according to an embodiment may obtain three-dimensional text data corresponding to at least one character from an internal memory or an external device. The processor 310 may receive a user input for inputting at least one character and obtain three-dimensional text data representing the at least one character based on the user input.

The processor 310 according to an embodiment may receive a user input corresponding to at least one character and obtain contour data corresponding to the at least one character. The processor 310 may obtain two-dimensional mesh data by connecting a plurality of first vertexes included in the contour data. The processor 310 may obtain, as three-dimensional text data, three-dimensional mesh data including two-dimensional mesh data as a first surface and including a second surface spaced apart from the first surface by a certain depth.

The processor 310 according to an embodiment may receive, through the user input unit 340, a user input corresponding to a first character string including a plurality of characters. The processor 310 may obtain contour data corresponding to each character included in the first character string. The processor 310 may obtain two-dimensional mesh data by connecting a plurality of first vertexes included in contour data corresponding to each character. The processor 310 may obtain a three-dimensional text data set including three-dimensional text data corresponding to each character included in the first character string.

The processor 310 according to an embodiment may control the display 320 to display the three-dimensional text data and the three-dimensional model on the screen.

The processor 310 according to an embodiment may render and display the three-dimensional model on the screen of the display 320. The processor 310 may control the display 320 to additionally display the three-dimensional text data corresponding to at least one character input by the user on the screen on which the three-dimensional model is displayed.

The processor 310 according to an embodiment may determine a position at which the three-dimensional text data will be arranged in the three-dimensional space, based on at least one of a user input or a distance from the three-dimensional text data to the surface of the three-dimensional model. The processor 310 according to an embodiment may determine the X-axis coordinate value and Y-axis coordinate value of the three-dimensional text data. The three-dimensional model processing apparatus 300 according to an embodiment may determine, based on the determined X-axis coordinate value and Y-axis coordinate value, the Z-axis coordinate value of the three-dimensional text data to be located close to the three-dimensional model.

The processor 310 according to an embodiment may determine the Z-axis coordinate value of the three-dimensional text data based on whether the text is input as an embossment or as an intaglio on the three-dimensional model.

As an example, when the text is input as an embossment on the three-dimensional model, the processor 310 may determine the position of the three-dimensional text data such that the first surface and second surface of the three-dimensional text data are located outside the three-dimensional model. The processor 310 may determine the position of the three-dimensional text data at which the sum of the vertical distances from the vertexes included in the second surface of the three-dimensional text data to the surface of the three-dimensional model is minimum.

As an example, when the text is input as an intaglio on the three-dimensional model, the processor 310 may determine the position of the three-dimensional text data such that the first surface and second surface of the three-dimensional text data are located inside the three-dimensional model. The processor 310 may determine the position of the three-dimensional text data at which the sum of the vertical distances from the vertexes included in the second surface of the three-dimensional text data to the surface of the three-dimensional model is minimum.

Also, the processor 310 may determine an angle of the three-dimensional text data based on a normal vector of the three-dimensional text data and a normal vector of the three-dimensional model.

The processor 310 according to an embodiment may determine whether the three-dimensional text data and the three-dimensional model are combinable with each other.

The processor 310 according to an embodiment may determine whether the three-dimensional text data and the three-dimensional model are combinable with each other, based on whether three-dimensional text data with a certain offset applied thereto and the three-dimensional model intersect each other. Three-dimensional text data with an offset applied thereto may include three-dimensional text data with a depth added thereto by the offset.

The processor 310 according to an embodiment may move a second vertex included in the second surface of the three-dimensional text data by a certain offset in order to obtain three-dimensional text data with an offset applied thereto. The processor 310 may determine a line connecting a first vertex of the first surface of the three-dimensional text data with the moved second vertex. The processor 310 may determine whether the line and the surface of the three-dimensional model intersect each other. The processor 310 may determine the number of lines intersecting the surface of the three-dimensional model among the lines connecting first vertexes of the first surface of the three-dimensional text data with second vertexes moved by a certain offset is greater than or equal to a reference value and determine, based on the determination results, whether the three-dimensional text data and the three-dimensional model are combinable with each other. For example, the processor 310 may determine that the three-dimensional text data and the three-dimensional model are combinable with each other, when all of the lines connecting the first vertexes of the first surface of the three-dimensional text data with the second vertexes moved by the certain offset intersect the surface of the three-dimensional model.

The processor 310 according to an embodiment may control the display 320 to display the determination results on the screen.

The processor 310 according to an embodiment may determine at least one of the color, shape, or brightness of the three-dimensional text data displayed on the screen, based on whether the three-dimensional text data and the three-dimensional model are combinable with each other.

The processor 310 according to an embodiment may determine at least one of the color, shape, or brightness of the three-dimensional text data based on the number of lines intersecting the surface of the three-dimensional model among the lines connecting the first vertexes of the first surface of the three-dimensional text data with the second vertexes moved by a certain offset.

For example, the processor 310 may determine the color of the three-dimensional text data as green, when all of the lines connecting the first vertexes of the first surface of the three-dimensional text data with the second vertexes moved by a certain offset intersect the surface of the three-dimensional model. When not all of the lines connecting the first vertexes with the second vertexes moved by a certain offset intersect the surface of the three-dimensional model but they intersect each other by a reference value or more, the processor 310 may determine the color of the three-dimensional text data as green. When at least one of the lines connecting the first vertexes with the second vertexes moved by a certain offset intersects the surface of the three-dimensional model but they intersect each other by less than a reference value, the processor 310 may determine the color of the three-dimensional text data as orange. When none of the lines connecting the first vertexes with the second vertexes moved by a certain offset intersects the surface of the three-dimensional model, the processor 310 may determine the color of the three-dimensional text data as red.

The processor 310 according to an embodiment may obtain a three-dimensional model with text added thereon when the three-dimensional text data and the three-dimensional model are combinable with each other. The processor 310 may obtain a three-dimensional model with text added thereon by combining the three-dimensional text data with a certain offset applied thereto on the three-dimensional model or deleting data corresponding to the three-dimensional text data with a certain offset applied thereto from the three-dimensional model.

The three-dimensional model processing method according to various embodiments of the present disclosure may be embodied in the form of program commands executable through various computer means and then may be recorded on a computer-readable recording medium. Also, according to an embodiment of the present disclosure, a computer-readable storage medium may have recorded therein one or more programs including at least one instruction for executing a three-dimensional model obtaining method.

The computer-readable storage medium may include program instructions, data files, and data structures either alone or in combination. Here, examples of the computer-readable storage medium may include magnetic media such as hard disks, floppy disks, and magnetic tapes, optical media such as CD-ROMs and DVDs, magneto-optical media such as floptical disks, and hardware devices such as ROMs, RAMs, and flash memories that are configured to store and execute program instructions.

Here, a machine-readable storage medium may be provided in the form of a non-transitory storage medium. Here, the ‘non-transitory storage medium’ may mean that the storage medium is a tangible device. Also, the ‘non-transitory storage medium’ may include a buffer in which data is temporarily stored.

According to an embodiment, an intraoral image displaying method according to various embodiments described herein may be included and provided in a computer program product. The computer program product may be distributed in the form of a machine-readable storage medium (e.g., a compact disc read only memory (CD-ROM)). Alternatively, the computer program product may be distributed (e.g., downloaded or uploaded) online through an application store or directly between two user devices (e.g., smart phones).

Although embodiments have been described above in detail, the scope of the present disclosure is not limited thereto and various modifications and improvements made by those of ordinary skill in the art by using the basic concept of the present disclosure defined in the following claims are also included in the scope of the present disclosure.

1. A method of adding text on a three-dimensional model representing an object, the method comprising:
obtaining three-dimensional text data corresponding to at least one character;
displaying the three-dimensional text data and the three-dimensional model on a screen;
determining whether the three-dimensional text data and the three-dimensional model are combinable with each other based on whether the three-dimensional text data with a certain offset applied thereto and the three-dimensional model intersect each other; and
displaying a result of the determining on the screen.

2. The method of claim 1, wherein the obtaining of the three-dimensional text data comprises:
receiving a user input about the at least one character;
obtaining contour data corresponding to the at least one character;
obtaining two-dimensional mesh data by connecting a plurality of first vertexes included in the contour data; and
obtaining, as the three-dimensional text data, three-dimensional mesh data including a first surface including the two-dimensional mesh data, and a second surface spaced apart from the first surface by a certain depth.

3. The method of claim 1, further comprising determining a position of the three-dimensional text data based on a user input.

4. The method of claim 1, further comprising:
receiving a user input for dragging the three-dimensional text data displayed on the screen to a certain position;
determining a reference point based on the certain position on the screen; and
determining a position of the three-dimensional text data based on a distance from the reference point to a surface of the three-dimensional model.

5. The method of claim 4, wherein the determining of the position of the three-dimensional text data comprises determining the position of the three-dimensional text data at which a first surface and a second surface of the three-dimensional text data are located outside the three-dimensional model and the distance from the reference point to the surface of the three-dimensional model is minimum.

6. The method of claim 4, wherein the determining of the position of the three-dimensional text data comprises determining the position of the three-dimensional text data at which a first surface and a second surface of the three-dimensional text data are located inside the three-dimensional model and the distance from the reference point to the surface of the three-dimensional model is minimum.

7. The method of claim 1, wherein the determining of whether the three-dimensional text data and the three-dimensional model are combinable with each other comprises:
moving a second vertex included in a second surface of the three-dimensional text data by the certain offset;
determining a line connecting a first vertex of a first surface of the three-dimensional text data with the moved second vertex; and
determining whether the line and a surface of the three-dimensional model intersect each other.

8. The method of claim 7, wherein the determining of whether the three-dimensional text data and the three-dimensional model are combinable with each other further comprises determining that the three-dimensional text data and the three-dimensional model are combinable with each other when a number of lines intersecting the surface of the three-dimensional model among lines connecting first vertexes of the first surface of the three-dimensional text data with second vertexes moved by the certain offset is greater than or equal to a reference number.

9. The method of claim 1, wherein the displaying of the result of the determining on the screen comprises determining at least one of a color, a shape, or brightness of the three-dimensional text data displayed on the screen based on whether the three-dimensional text data and the three-dimensional model are combinable with each other.

10. The method of claim 1, further comprising obtaining a three-dimensional model with text added thereon by combining the three-dimensional text data with the certain offset applied thereto on the three-dimensional model or by deleting data corresponding to the three-dimensional text data with the certain offset applied thereto from the three-dimensional model.

11. A three-dimensional model processing apparatus for processing a three-dimensional model representing an object, the three-dimensional model processing apparatus comprising:
at least one processor configured to obtain three-dimensional text data corresponding to at least one character; and
a display displaying the three-dimensional text data and the three-dimensional model,
wherein the at least one processor is further configured to:
determine whether the three-dimensional text data and the three-dimensional model are combinable with each other based on whether the three-dimensional text data with a certain offset applied thereto and the three-dimensional model intersect each other; and
control the display to display a result of the determining on a screen.

12. The three-dimensional model processing apparatus of claim 11, wherein the at least one processor is further configured to:
receive a user input about the at least one character;
obtain contour data corresponding to the at least one character;
obtain two-dimensional mesh data by connecting a plurality of first vertexes included in the contour data; and
obtain, as the three-dimensional text data, three-dimensional mesh data including a first surface including the two-dimensional mesh data, and a second surface spaced apart from the first surface by a certain depth.

13. The three-dimensional model processing apparatus of claim 11, wherein the at least one processor is further configured to determine a position of the three-dimensional text data based on a user input.

14. The three-dimensional model processing apparatus of claim 11, wherein the at least one processor is further configured to:
receive a user input for dragging the three-dimensional text data displayed on the screen to a certain position;
determine a reference point based on the certain position on the screen; and
determine a position of the three-dimensional text data based on a distance from the reference point to a surface of the three-dimensional model.

15. The three-dimensional model processing apparatus of claim 14, wherein the at least one processor is further configured to determine the position of the three-dimensional text data at which a first surface and a second surface of the three-dimensional text data are located outside the three-dimensional model and the distance from the reference point to the surface of the three-dimensional model is minimum.

16. The three-dimensional model processing apparatus of claim 14, wherein the at least one processor is further configured to determine the position of the three-dimensional text data at which a first surface and a second surface of the three-dimensional text data are located inside the three-dimensional model and the distance from the reference point to the surface of the three-dimensional model is minimum.

17. The three-dimensional model processing apparatus of claim 11, wherein the at least one processor is further configured to:
move second vertexes included in a second surface of the three-dimensional text data by the certain offset; and
determine that the three-dimensional text data and the three-dimensional model are combinable with each other when a number of lines intersecting a surface of the three-dimensional model among lines connecting first vertexes of a first surface of the three-dimensional text data with the moved second vertexes is greater than or equal to a reference number.

18. The three-dimensional model processing apparatus of claim 11, wherein the at least one processor is further configured to determine at least one of a color, a shape, or brightness of the three-dimensional text data displayed on the screen based on whether the three-dimensional text data and the three-dimensional model are combinable with each other.

19. The three-dimensional model processing apparatus of claim 11, wherein the at least one processor is further configured to obtain a three-dimensional model with text added thereon by combining the three-dimensional text data with the certain offset applied thereto on the three-dimensional model or by deleting data corresponding to the three-dimensional text data with the certain offset applied thereto from the three-dimensional model.

20. A computer-readable recording medium having recorded thereon a program comprising at least one instruction for performing, by a computer, a method of adding text on a three-dimensional model, the method comprising:
obtaining three-dimensional text data corresponding to at least one character;
displaying the three-dimensional text data and the three-dimensional model on a screen;
determining whether the three-dimensional text data and the three-dimensional model are combinable with each other based on whether the three-dimensional text data with a certain offset applied thereto and the three-dimensional model intersect each other; and
displaying a result of the determining on the screen.
